(19) United States
(12) Patent Application Publication
(10) Pub. No.: US 2015/0095103 A1
(43) Pub. Date: Apr. 2, 2015

(54) CREATING AND MANAGING COMMERCE INSIGHTS IN WASTE MANAGEMENT

(71) Applicant: International Business Machines Corporation, Armonk, NY (US)

(72) Inventors: Nithya Rajamani, Hyderabad (IN); Thulasi Krishna Reddy Sirigireddy, Hyderabad (IN)

(73) Assignee: International Business Machines Corporation, Armonk, NY (US)

(21) Appl. No.: 14/038,851

(22) Filed: Sep. 27, 2013

(51) Int. Cl. G06Q 30/02; G06Q 10/00

(52) U.S. Cl. CPC G06Q 30/0201; G06Q 10/30
USPC 705/7.29

(57) ABSTRACT

Methods and arrangements for creating and managing commercial insights in waste management. Codes of discarded products which enter a receptacle bin are scanned. There are provided, to an external entity, data relating to discarding of the products, the data including spatial location data and at least one of: temporal data relating to the discarding of the products, and product-specific data. Other variants and embodiments are broadly contemplated herein.

### BACKGROUND

Smart waste management is gaining ground in many cities throughout the world. However, there is usually little more involved than pure resource management, thus falling far short of leveraging data and insights from waste collection and management for a tremendous range of uses.

### BRIEF SUMMARY

In summary, one aspect of the invention provides a method of creating and managing commercial insights in waste management, the method comprising: utilizing a scanner to scan codes of discarded products which enter a receptacle bin; and providing to an external entity data relating to discarding of the products, the data including spatial location data and at least one of: temporal data relating to the discarding of the products, and product-specific data.

Another aspect of the invention provides an apparatus for creating and managing commercial insights in waste management, the apparatus comprising: at least one processor; and a computer readable storage medium having computer readable program code embodied therewith and executable by the at least one processor, the computer readable program code comprising: computer readable program code configured to utilize a scanner to scan codes of discarded products which enter a receptacle bin; and computer readable program code configured to provide to an external entity data relating to discarding of the products, the data including spatial location data and at least one of: temporal data relating to the discarding of the products, and product-specific data.

An additional aspect of the invention provides a computer program product for creating and managing commercial insights in waste management, the computer program product comprising: a computer readable storage medium having computer readable program code embodied therewith, the computer readable program code comprising: computer readable program code configured to utilize a scanner to scan codes of discarded products which enter a receptacle bin; and computer readable program code configured to provide to an external entity data relating to discarding of the products, the data including spatial location data and at least one of: temporal data relating to the discarding of the products, and product-specific data.

A further aspect of the invention provides a method comprising: providing a scanner at a receptacle bin that accepts commercial product items that have been encoded; scanning encoded data on discarded commercial product items which enter the receptacle bin; combining the scanned data with other available sources of data, the scanned data and other available sources of data comprising spatio-temporal data; the other available sources of data including at least one of: data relating to events, data from sensors, data from social media, and external data sources; and providing to an external entity data relating to discarding of the commercial product items.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1a illustrates a first conventional approach to waste management.

FIG. 1b illustrates a second conventional approach to waste management.

FIG. 2 illustrates an approach to waste management that involves a commerce-based strategy.

FIG. 3 sets forth a process more generally for creating and managing commercial insights in waste management.

FIG. 4 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

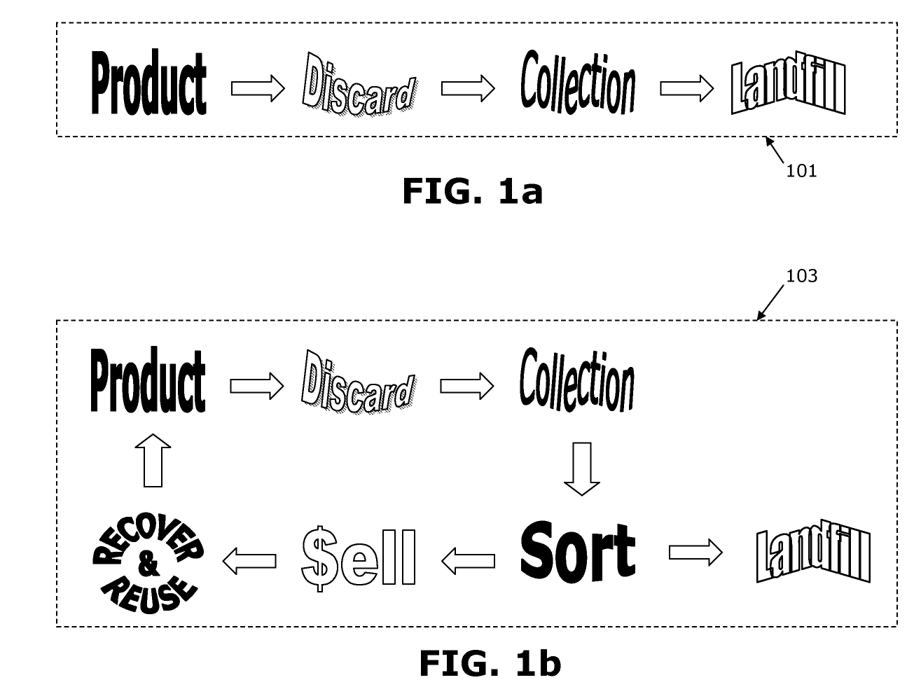

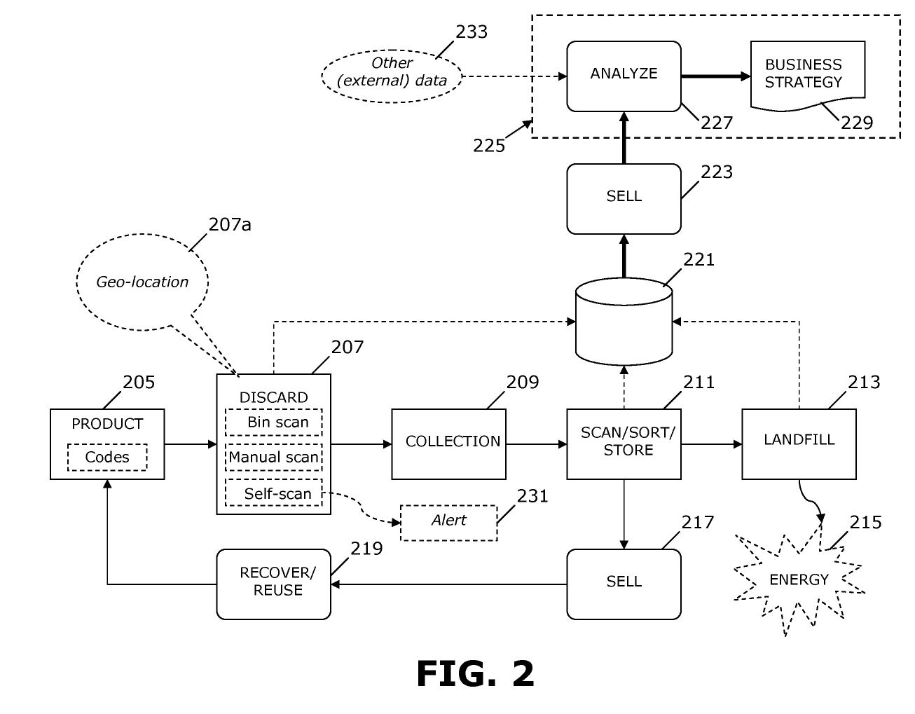

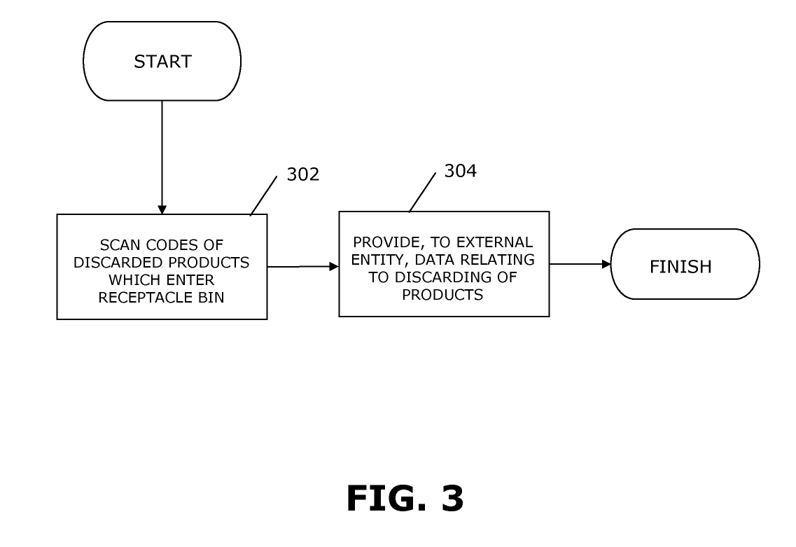

Specific reference will now be made herebelow to FIGS. 1a-2. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1a-2 can be performed or utilized by way of a processing unit or units and system memory such as those indicated, respectively, at 16′ and 28′ in FIG. 3, whether on a server computer, a client computer, a node computer in a distributed network, or any combination thereof.

Conventionally, there has been no sufficient connection between waste management and commerce that would permit the creation of meaningful insights from discarded garbage. While a traditional view of waste management, “cradle to grave”, continues to evolve into a view of pure resource management through recycling (“cradle to cradle”), there has been little to no effort towards manifesting a “cradle to commerce” viewpoint in waste management. For example, while recycling has come to represent an important component of waste management in general, personal financial incentives could also be leveraged further to encourage proper trash disposal in public spaces outside of establishments, and obtain commercially valuable insights from the trash as well.

Generally, smart trash and recycling bins have become more popular in public places; these involve the placement of sensors in the bins, which track the materials being deposited. There also have existed efforts to improve recycling from homes, which includes providing home-based containers with an RFID (radio frequency identification) reading capability that tracks household recycling and can be tied to redeemable incentives for pickup.

Generally, a recognition has been missing that trash (recyclable or otherwise) can potentially be very valuable, not just in terms of physical recycle value, but in terms of information value, including analytics and insights for smarter commerce. Currently, firms only manage to obtain a fragmented view of their own supply chain insights (e.g., they might get information on quantity stocked vs. sold with some large distributers or retailers, but the information is often incomplete and only their own). Cities that own data from collected trash, e.g., from smart bins, could also leverage such information to make more revenue from waste. Also, there is tremendous room for improvement in providing incentives for an individual to make a proper choice while throwing trash in a public place or other establishment (other than home).

As such, several obstacles currently exist towards effecting improvements such as those discussed above. Among these obstacles are a lack of complete end-to-end supply chain information for companies on consumption of their own and competitors' products, a lack of information on consumption patterns (of all types of products/brands consumed) at a spatio-temporal level in cities for targeted marketing and logistics strategies, and a lack of incentives at an individual level to recycle outside of the home (e.g., at public places and establishments) based on specific product/brand/seller attributes (e.g., via offering rebates/coupons instead of just monetary incentives).

Accordingly, there are broadly contemplated herein, in accordance with at least one embodiment of the invention, systems and methods for gathering commerce insights from data gathered by a waste management system. Thus, a smart system is contemplated herein for collecting commerce insights from waste, and a method is contemplated to create, process, analyze, subscribe and consume such commerce insights.

Further, there are broadly contemplated herein, in accordance with at least one embodiment of the invention, systems and methods towards public incentive mechanisms for recyclable waste in a “smarter” waste management system. Thus, there is contemplated herein a system and method to create, claim and process incentives for discarding recyclables, as well as to maintain smart waste management.

FIG. 1a illustrates a first conventional approach to waste management (101). In this “cradle to grave” approach, trash is simply disposed of, wherein a product is discarded, then collected (e.g., via a municipal garbage truck) and then dumped in a landfill. This approach often involves little to no use of information technology (IT). While contract, order management and accounting software may be involved, along with route optimization software, there is little involved with B2B (business to business) data exchange, or automated data reporting. To price complex contracts, waste management (WM) companies traditionally have physically sorted through trash to determine components and a manner of pricing the same, which misses out on potential benefits of nuanced insights.

FIG. 1b illustrates a second conventional approach to waste management (103). This is a recycling, or “cradle to cradle” approach, where after collection a sorting step can send trash either to the landfill (e.g., for non-recoverable material) or to a market (selling) structure where recoverable materials such as plastic, wood and fiber can be sold to appropriate concerns for recovery and reuse. (At best, trash in the landfill can be converted to energy.) In this recycling context, a global closed loop integrated supply chain has been sought after but difficult to achieve, due to fragmentation at various stages. As such, true integration of such a supply chain may well necessitate fine-grained automatic tracking of materials at each stage, consumer education to increase the supply of recovered material, analysis tools to manage any data that are being collected (to then be fed back into each stage of the supply chain to optimize process), and easy-to-use, affordable tools at each stage of the supply chain.

FIG. 2 illustrates an approach to waste management that involves a commerce-based strategy, in accordance with at least one embodiment of the invention. Here, a recognition is involved that material and information that can be recovered from trash may have significant commercial value. As shown, a product (or products) 205 including one or more scannable codes may be discarded (207) at a bin (such as a public/municipal bin) and, in a manner to be appreciated more fully below, can be subjected to a scan via the bin itself or through other manual methods (e.g., as part of a waste collection process). (A consumer self-scan can also be implemented here, in a manner to be discussed more fully below.) The scannable code(s) can be embodied, e.g., by a QR (quick response) code or RFID (radio frequency ID), or essentially any other suitable type of code. Also in a manner to be appreciated more fully below, a geo-location 207a of the bin can be obtained and considered in combination with other data. After collection (209), trash can be scanned and sorted. Here, it can progress to a landfill 213 for energy conversion (215) or, as noted above, to a recycling scheme via being sold (217) and then recovered/reused (219).

As a result of the post-collection scanning (at 211), however, in accordance with at least one embodiment of the invention, data so obtained (e.g., about the nature and number of products collected) can be stored in a database 211 that then can be used for obtaining commercial insights. Such data may also be combined with other data incoming from the bin (207), which may include data scanned by the bin or via consumer self-scan (towards incentives), as well as the bin geo-location 207a. Further, data may be fed in from the landfill 213, such as the nature and number of products sent to the landfill as well as regarding any subset that may have been used for energy conversion. Data from the database 221 can then be sold (223) to any interested concern 25 (e.g., a commercial concern) which may then conduct its own analysis 227 in developing a business strategy 229 (relating to its products, but possibly also in consideration of patterns relating to competitors' products). These data (for analysis 227) may also be combined with other data from external sources (e.g., social media data, data from other sensors or external databases, etc.) that could be event-related, or related to aspects that are not necessarily an inherent part of a waste management closed loop system.

In accordance with at least one embodiment of the invention, by way of encoding information, just about every product that is discarded after use (wrappers, cans, bottles, etc.) can be understood to have one or more machine readable codes (e.g., QR or RFID code) that encodes information such as the type of discard (e.g., paper/metal/plastic), brand/product category (e.g., the manufacturing company, category of consumer or electronics), product code, and recycle value, etc. A retailer selling the item could embed additional codes to represent the place where it is sold and time of stocking. To process such information, smart bins can be placed in public places and establishments (homes, offices, commercial places, etc.). When a person throws in an item (recyclable or otherwise), the sensor in the bin reads the machine readable code of the items and processes it. One type of processing could involve providing a notification of location and codes to a central server at regular intervals.

In accordance with at least one embodiment of the invention, to create insights, information collected from all trash across a region or city can be analyzed, e.g., via geo-spatial temporal analytics together with other information code attributes and other city events/landmarks (e.g., based on temporal and location correlation). Businesses and other entities can subscribe to the waste management authority (that owns the data) for a specific set of product attributes, and receive alerts. These entities can then use the insights to drive marketing strategy, competitive strategy, and logistics strategy.

By way of a working example of obtaining commerce-based insights from data related to trash, in accordance with at least one embodiment of the invention, a soft drink can may be encoded with details such as the product name, product type, and recycle value. A user may then consume the drink and discard it in a “smart” public recycling bin. A sensor in the bin may then capture details of the discarded product, timestamp the time of disposal and then send such information to the database 211, e.g., on a periodic basis. Geo-location information 207a of the bin may also be included in such a transmission. Alternatively, all such data may also be captured by any existing embodiments of a smart waste management process. Generally, all collected data, including geo-location information 207a may be used in analysis 227 to determine, e.g., the types of products, and corresponding brands, that might be discarded in a region such as a city. As such, a soft drink company, producing a particular brand (Brand ‘A’, for the purposes of illustration), may purchase the collected information, deduce patterns therefrom (such as spatial diffusion patterns, based at least on the bin's geo-location) and then create a marketing strategy (e.g., for the particular vicinity of the bin geo-location) via which to compete with another company.

By way of elaboration, in accordance with at least one embodiment of the invention, soft drink company ‘A’ subscribes for the information gathered by a waste management authority and comes to understand the consumption patterns (e.g., can or bottle, size, etc.) of its products and also in general for beverages of other brands. It can find seasonal or event-specific demand patterns and also spatial patterns. It can use these data to decide competitive strategy against another company, a marketing strategy (e.g., targeting specific regions, establishments or even events), and/or a logistics strategy (e.g., via suggesting that large distributors amend their supply chain or institute promotions to remedy a “gap” or “glut” in distribution or sales).

In accordance with at least one embodiment of the invention, arrangements could be put in place to create incentives for consumer scanning of items they are disposing. Accordingly, just before discard, a consumer may first scan a machine readable code for a recyclable material, which can be stored in a smartphone application such as a “recycle kitty” (or tracker) that tracks such scans. The consumer may then drop the recyclable item into a public smart bin, which in turn captures details of the discarded product and an incentive value associated with it. The smart bin can generate a receipt (e.g., an electronic receipt that gets sent to the consumer) and send data to a central database or server (211). The consumer may then cash in from his or her recycle kitty (or application) to receive money, rebates, coupons, etc.

In a variant of the arrangement described above, in accordance with at least one embodiment of the invention, a consumer may not have to scan a product manually but instead can simply dispose of it in a smart bin and then receive a receipt (e.g., electronic receipt) for cashing in.

In accordance with another variant, according to at least one embodiment of the invention, a backend server (e.g., which houses database 211) can be used to validate cashed-in incentive claims or receipts for any fraudulent activity.

In accordance with at least one embodiment of the invention, a consumer may notice some problems with a bin and choose to report the same. Accordingly, he or she may send an alert 231 to the waste management company or other appropriate authority; this may be facilitated by actually scanning a code associated with the bin itself. In resolving the issue, backend supervisors may then transmit an incentive receipt to the consumer, which may then be cashed in using a process similar to those described herein for recycling incentives.

In accordance with at least one variant embodiment of the invention, a retailer which sells given brands may subscribe to insights such as those obtained in a manner described herein. One or the other may then plan promotions to sell more of a product at a particular location, or even in accordance with a particular type of planned event, based on patterns detected through such insights.

By way of brief recapitulation, in accordance with at least one embodiment of the invention, commerce-based insights may be based on analyzing geo-spatial temporal data collected from waste. Analytics can be embodied by simple descriptive analytics or advanced spatio-temporal analytics. Analytics can be driven towards managing a supply chain for waste recovery, towards managing system operations for effective waste management, towards managing incentive systems or towards developing commerce insights for business firms. As mentioned above, interested organizations may subscribe for analytics and insights on specific attributes of data (e.g., data on their own products and others'). For example, one company might want to know the descriptive statistics of consumption of its products within a given region, while another might want to know competitive strengths of its products against another brand within a region. Insights could be used to change marketing strategy or to enhance supply chain benefits. For example, if in a given region a first brand sells more than a second brand in a larger size category, a competitive strategy could be to build more inroads into small retailers to stock smaller sizes and/or offer more discounts in a smaller category.

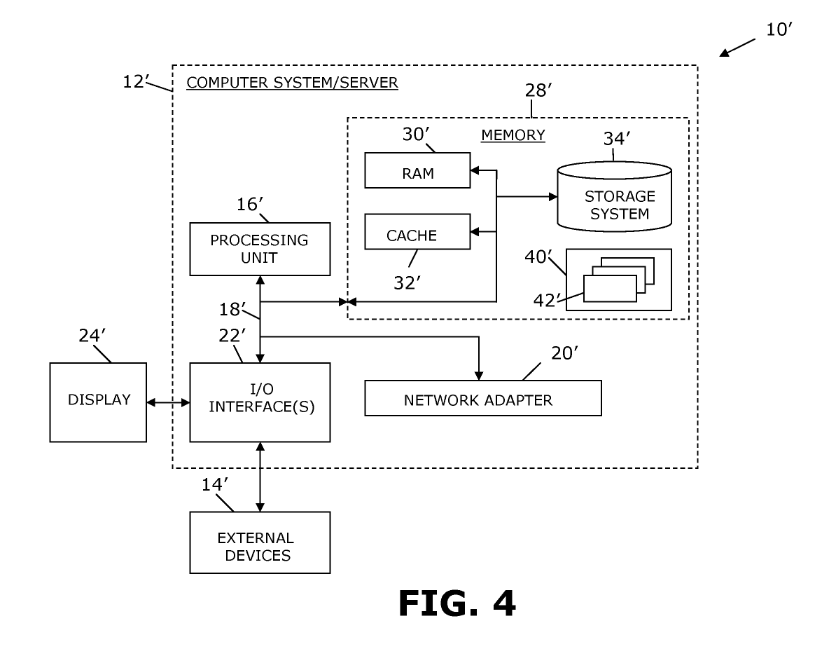

FIG. 3 sets forth a process more generally for creating and managing commercial insights in waste management, in accordance with at least one embodiment of the invention. It should be appreciated that a process such as that broadly illustrated in FIG. 3 can be carried out on essentially any suitable computer system or set of computer systems, which may, by way of an illustrative and non-restrictive example, include a system such as that indicated at 12′ in FIG. 4. In accordance with an example embodiment, most if not all of the process steps discussed with respect to FIG. 3 can be performed by way of a processing unit or units and system memory such as those indicated, respectively, at 16′ and 28′ in FIG. 4.

As shown in FIG. 3, in accordance with at least one embodiment of the invention, codes of discarded products which enter a receptacle bin are scanned (302). There are provided, to an external entity, data relating to discarding of the products, the data including spatial location data and at least one of: temporal data relating to the discarding of the products, and product-specific data (304).

Referring now to FIG. 4, a schematic of an example of a cloud computing node is shown. Cloud computing node 10′ is only one example of a suitable cloud computing node and is not intended to suggest any limitation as to the scope of use or functionality of embodiments of the invention described herein. Regardless, cloud computing node 10′ is capable of being implemented and/or performing any of the functionality set forth hereinabove. In accordance with embodiments of the invention, computing node 10′ may not necessarily even be part of a cloud network but instead could be part of another type of distributed or other network, or could represent a stand-alone node. For the purposes of discussion and illustration, however, node 10′ is variously referred to herein as a “cloud computing node”.

In cloud computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12′ in cloud computing node 10 is shown in the form of a general-purpose computing device. The components of computer system/server 12′ may include, but are not limited to, at least one processor or processing unit 16′, a system memory 28′, and a bus 18′ that couples various system components including system memory 28′ to processor 16′.

Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture. Such an article of manufacture can include instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method of creating and managing commercial insights in waste management, said method comprising:
utilizing a scanner to scan codes of discarded products which enter a receptacle bin; and
providing to an external entity data relating to discarding of the products, the data including spatial location data and at least one of: temporal data relating to the discarding of the products, and product-specific data.

2. The method according to claim 1, wherein the external entity comprises a business concern.

3. The method according to claim 2, wherein the data comprise data to be used in harvesting commercial insights to assist in developing strategy for at least one of: marketing, business competition, a supply chain and business expansion.

4. The method according to claim 3, wherein the data are provided on a subscription basis to the business concern.

5. The method according to claim 3, wherein the commercial insights include information comprising at least one member from the group consisting of: event-related information, landmark-related information, temporal information, location information, information relating to at least one product of the business concern, and information relating to at least one product of a competitive business concern.

6. The method according to claim 1, wherein the external entity comprises a consumer.

7. The method according to claim 6, comprising providing incentives to the consumer to dispose of recyclable waste.

8. The method according to claim 6, comprising providing incentives to the consumer to report a deficient receptacle bin.

9. The method according to claim 8, wherein said providing of incentives comprises availing the receptacle bin of a scannable code for the consumer to use in reporting the bin.

10. The method according to claim 6, wherein said providing comprises delivering the data to a consumer recycling tracker.

11. The method according to claim 10, wherein said delivering comprises employing an application on a consumer smart phone, the application including use of a consumer recycling tracker.

12. The method according to claim 10, wherein the scanner comprises a smart phone scanner which permits a manual scan of the discarded products.

13. The method according to claim 1, wherein the data include temporal data relating to the discarding of the products.

14. The method according to claim 1, comprising combining the data with additional external data including at least one of: sensor data, social media data and data from at least one external database.

15. The method according to claim 1, wherein:
the data include product-specific data; and
the product-specific data include at least one of: brand data, product type data, product category data, a product code, product size data, and a recycle value of a product;
the recycle value comprising a value related to at least one of: money, mobile money, at least one coupon and at least one rebate.

16. The method according to claim 1, wherein the scanner comprises a scanner included with the receptacle bin to scan products as they enter the receptacle bin.

17. The method according to claim 1, wherein the external entity comprises an entity which manages a smart waste management process.

18. An apparatus for creating and managing commercial insights in waste management, said apparatus comprising:
at least one processor; and
a computer readable storage medium having computer readable program code embodied therewith and executable by the at least one processor, the computer readable program code comprising:
computer readable program code configured to utilize a scanner to scan codes of discarded products which enter a receptacle bin; and
computer readable program code configured to provide to an external entity data relating to discarding of the products, the data including spatial location data and at least one of: temporal data relating to the discarding of the products, and product-specific data.

19. A computer program product for creating and managing commercial insights in waste management, said computer program product comprising:
a computer readable storage medium having computer readable program code embodied therewith, the computer readable program code comprising:
computer readable program code configured to utilize a scanner to scan codes of discarded products which enter a receptacle bin; and
computer readable program code configured to provide to an external entity data relating to discarding of the products, the data including spatial location data and at least one of: temporal data relating to the discarding of the products, and product-specific data.

20. A method comprising:
providing a scanner at a receptacle bin that accepts commercial product items that have been encoded;
scanning encoded data on discarded commercial product items which enter the receptacle bin;
combining the scanned data with other available sources of data, the scanned data and other available sources of data comprising spatio-temporal data;
the other available sources of data including at least one of: data relating to events, data from sensors, data from social media, and external data sources; and
providing to an external entity data relating to discarding of the commercial product items.
